(19) United States
(12) Patent Application Publication
(10) Pub. No.: US 2015/0224654 A1
(43) Pub. Date: Aug. 13, 2015

(54) ROTARY SHAVING HEAD HAVING A LOCKING RETAINER

(71) Applicant: KONINKLIJKE PHILIPS N.V., EINDHOVEN (NL)

(72) Inventor: Jelte Steur, Eindhoven (NL)

(21) Appl. No.: 14/418,823

(22) PCT Filed: Jul. 25, 2013
(86) PCT No.: PCT/IB2013/056093

§ 371 Date: Jan. 30, 2015

Related U.S. Application Data
(60) Provisional application No. 61/679,098, filed on Aug. 3, 2012.

(51) Int. Cl. B26B 19/14

(52) U.S. Cl. CPC B26B 19/14

(57) ABSTRACT

A rotary shaving head 3 has at least one cutter unit 10, each cutter unit comprising a cap 16 having an external surface 20 with hair-entry openings 18 for engaging the skin of a user; and a rotary cutter 24 having cutting elements 32 supported by a carrier 26, the rotary cutter being locatable within and rotatable with respect to the cap. The shaving head further comprises: a support member 12 for supporting the cutter unit; and a retainer 30, arranged to engage and lock with the support member by relative rotation therewith and retain the cap and the rotary cutter therebetween, wherein the retainer comprises an annular body 36, 38 defining a drive opening 42, the annular body being provided with one or more holes 40 allowing cut hairs to pass through. The holes are shaped as directional indicators indicating a direction of rotation of the retainer with respect to the support. As a result of the pro posed design, a user can identify the retainer as being a rotational component even though it is located within the support member. In an alternative embodiment, the retainer is provided with gripping formations which are formed as directional indicators.

### BACKGROUND OF THE INVENTION

1. Field of the Invention

The present invention relates to shaving devices of the rotary type and in particular to a rotary shaving head having at least one cutter unit and a retainer for locking the elements of the cutter unit together. The invention also relates to a shaver incorporating such a rotary shaving head.

2. Description of the Related Art

Electrical shavers are frequently used consumer items which generally comprise an assembly of moving and stationary elements that interact to cut the hairs at the surface of a user's skin. The shaving elements such as a cutter and cap or guard, have to be fixed to the body of the shaver. For greater comfort and convenience, the shaving elements may be resiliently mounted and are generally removable for cleaning and maintenance. In rotary shavers, the shaving elements usually comprise an outer cap and a rotating cutter located within the cap. The outer cap has apertures allowing hairs to protrude therethrough and the rotary cutter has internal cutting elements that move past the apertures to cut the hairs. In general, the cap and rotary cutter are held together with other components as a cutter unit and the shaver may have a number of cutter units mounted together e.g. in a bracket forming part of a head of the shaver. Rotary shavers with two or three cutter units are most common.

In many shaver designs, the bracket and cutter unit or units can be removed or hinged away from the remainder of the shaver so that hair can be removed from a hair chamber located within the body or head. On removing the bracket or otherwise opening the hair chamber, it is generally desirable that the components of the cutter units stay together. These components may include the cap and rotary cutter as described above but also include other parts such as springs, washers, supports and drive members required for operation of the cutter unit and its interaction with the motor which is located within the body of the shaver. Also, once opened, it should be possible to disassemble the cutter unit in order to clean or replace these individual components. To this end, a mechanism or retainer is usually provided to hold these components together. In particular, for shavers in which the individual cutter units are moveable or floating with respect to each other, this mechanism which holds the cutter unit together will usually be associated with a single cutter unit.

Existing designs of shaving head use relatively complicated locking arrangements to hold the components together. Once the head has been removed for cleaning, opening of the locking arrangement to disassemble the cutter units is not always self evident. Often, a user will not even realise that an additional disassembly step is possible or required and will attempt to clean the head in its assembled condition. One design in which a head assembly can be disassembled is shown in US2009/0320294. The disclosed design includes floating supports described as cutter circumferential rims, which each carry a cap. A rotating cutter is held within the cap by a cutter retaining plate which engages with the rim. The retaining plate is provided with openings allowing hairs to pass through and a system of springs and lugs is used to hold the retaining plate in position. Certain designs have proposed markings for assisting a user in identifying how to remove such a retainer. Nevertheless, the available space for application of visible markings onto a retainer is limited.

In light of the existing designs, it would be desirable to provide a shaving head construction which facilitates easy disassembly and which is intuitive for a user to open.

### BRIEF SUMMARY OF THE INVENTION

According to the invention there is provided a rotary shaving head having at least one cutter unit, wherein each cutter unit comprises a cap, having an external surface with hair-entry openings for engaging the skin of a user; and a rotary cutter, having cutting elements supported by a carrier, the rotary cutter being locatable within and rotatable with respect to the cap, and wherein the shaving head further comprises a support member for supporting the cutter unit and a retainer, arranged to engage and lock with the support member by relative rotation therewith and retain the cap and the rotary cutter therebetween, wherein the retainer comprises an annular body defining a drive opening, the body being provided with one or more holes allowing cut hairs to pass through, and the holes are shaped as directional indicators indicating a direction of rotation of the retainer with respect to the support member. As a result of the proposed design, a user can identify the retainer as being a rotational component even though it is located within the support member. The directional indicators provide an intuitive and also tactile indication of how to open or otherwise release the retainer. In general, the indicated direction of rotation will be the direction of unlocking Nevertheless, it will be understood that it may also indicate the direction of locking or in fact both directions.

The retainer and support member may comprise appropriate locking elements that engage and lock against one another by rotation. Most preferably the locking elements comprise bayonet elements having lugs on an outer circumference of the retainer which engage beneath inwardly extending flanges formed on the support member. Nevertheless, it will be understood that any other suitable rotational locking arrangement may be considered.

Preferably, the locking elements are provided with detent elements to prevent undesired loosening of the retainer during use. The detent elements may be in the form of snap or spring elements formed on engaging surfaces of the locking elements. Overcoming the detent will require a threshold force to be applied. Although these detents will, in general be formed on the locking elements, it will be understood that they may alternatively be provided at other locations between the retainer and support member. The retainer and the support member are preferably both formed of plastic material and the detents may operate by snap action due to the resiliency of the material. It will be understood that other materials may also be considered e.g. metals.

In a further advantageous embodiment of the invention, the retainer is provided with gripping protrusions for rotating the retainer with respect to the support. The gripping protrusions may allow a user to grasp and turn the retainer by inserting their fingers into the cap. Alternatively, they may be engaged by a suitable tool or other object. To provide this function, the gripping protrusions preferably protrude from the surface of the retainer by at least sufficient that a force can be applied to overcome the force required to release the locking elements or detents described above. A height of at least 0.5 mm is desirable, preferably at least 1 mm. In a still further preferred embodiment, these gripping protrusions may be embodied as further directional indicators which also indicate a direction of rotation of the retainer with respect to the support member. They may thus have the shape of arrows, chevrons, triangles or the like, pointing in an intended direction of movement. In this case, the directional indicators provided by the shaped holes may be omitted and plain holes may be used instead, given that the gripping protrusions provide sufficient indication of the direction of rotation.

In a most preferred embodiment, the holes may be formed in the shape of arrows, chevrons or the like. In this context it will be understood that arrows or chevrons should be construed in the broadest possible meaning of this term as being any form that indicates movement in the rotational direction. It will also be understood that although reference is made to holes, these holes do not necessarily need to be enclosed around their periphery and could be at least partially open to an outside or an inside of the annular body. The function of the holes is to allow hairs to pass through the retainer while retaining the necessary rigidity in order to lock against the support.

In one particular embodiment, the retainer is provided with at least three holes arranged around a circumference of the annular body. The holes may be identical although this need not necessarily be the case. Most preferably, four holes or more are provided.

According to one form of the retainer, the annular body may comprise an inner ring which surrounds the drive opening to keep the rotary cutter in position, the one or more holes being located radially outwardly of the inner ring. The annular body may also have an outer ring which may engage with the support member and which can carry the locking elements. The holes may then be formed between the inner ring and the outer ring e.g. by cross-members.

In another form of the retainer, the annular body may be provided with lifting elements for assisting a user in withdrawing the retainer from the support member once unlocked. The lifting elements may comprise undercut portions at an outer circumference of the inner ring, assisting a user in exerting a retraction force.

As discussed above, the function of the holes is to allow cut hairs and other shaving debris to pass through the retainer towards a hair collection chamber. Preferably, the annular body is provided with tapered surfaces at a side directed towards the external surface of the cap. The tapered surfaces facilitate passage of cut hairs through the one or more holes.

The shaving head according to the present invention may be constructed in various forms. In a preferred form of head, the cutter unit comprises a spring-loaded spindle resiliently engaged with the carrier and passing through the drive opening when the retainer is engaged and locked with the support member. Such a spring-loaded coupling is advantageous for providing flexibility with respect to the shaver drive, in particular if a plurality of cutter units is provided which can float with respect to each other. Nevertheless, the skilled person will be aware that an engaging drive spindle on the side of the body may also be spring loaded.

In a further preferred embodiment, the support member is a pivotable, skin supporting rim which surrounds the cap and is mounted to pivot with respect to a housing of the shaving head during use, as generally described in WO96/02368, the contents of which are incorporated herein by reference in their entirety. Such an arrangement allows the support member to better follow the skin of a user during shaving. Such an arrangement is particularly advantageous in the case that the head comprises a plurality of cutter units, each supported by a respective pivotable, skin supporting rim. In this manner, during shaving, each cap support can move with respect to the housing. The housing may have a number of apertures formed therethrough with a support member being pivotally held within each of the apertures. Nevertheless, it will be understood that a plurality of cutter units may be mounted together without relative movement. In particular, the support members of each cutter unit may be integrally formed together as part of the housing.

In a further embodiment, the support member may form part of a first housing part of the shaving head which can be moved or pivoted relative to a second housing part of the shaving head into an open position allowing access to the retainer for unlocking the retainer from the support member. Such a first housing part is sometimes referred to as a bracket assembly. The skilled person will also understand that the present invention is equally applicable to situations where the shaving head as a whole is removed from the main body of the shaver to provide access to the retainers.

The invention also relates to a shaver comprising a main body and a shaving head as described above. As a result of the retainer, each of the cutter units can be individually disassembled with ease for cleaning or maintenance.

### BRIEF DESCRIPTION OF THE DRAWINGS

Further features and advantages of the invention will be appreciated upon reference to the following drawings of a number of exemplary embodiments, in which:

FIG. 1 shows a perspective view of a shaver according to the present invention;

FIG. 2 shows a perspective view of an underside of part of the head of the shaver of FIG. 1;

FIG. 2a is a detail view of part of FIG. 2;

FIG. 3 shows a vertical cross-section through one of the cutter units of FIG. 2 along line III-III;

FIG. 4 shows a perspective view of the retainer according to the present invention;

FIG. 5 shows a horizontal cross-section through the cutter unit of FIG. 3 along line V-V;

FIGS. 6a to 6i show plan views of alternative retainers according to the present invention; and

FIG. 7 shows a perspective view of a retainer according to a second aspect of the present invention.

### DESCRIPTION OF ILLUSTRATIVE EMBODIMENTS

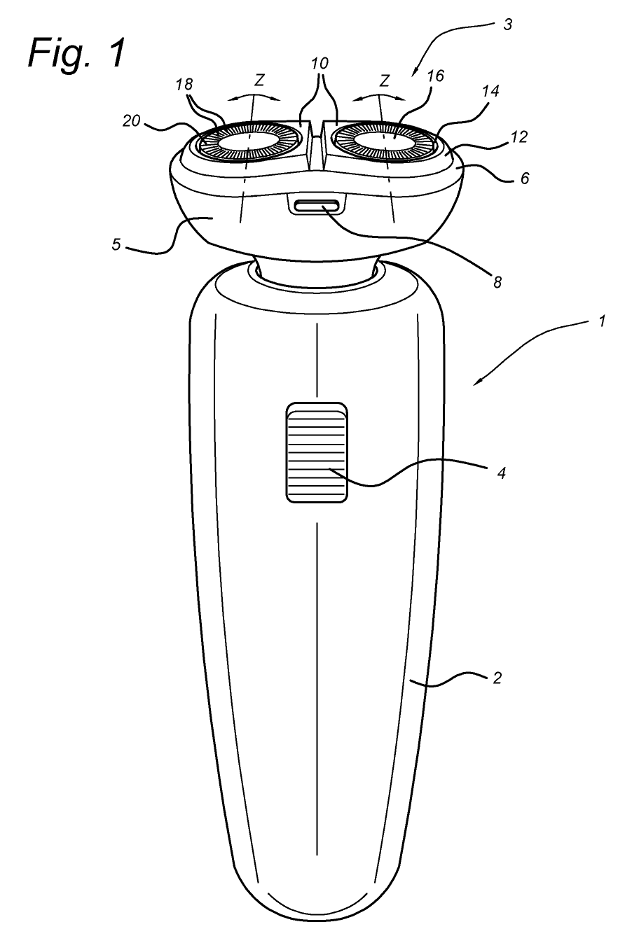

FIG. 1 shows a perspective view of a shaver 1 according to the invention.

The shaver 1 has a main body 2 and a head 3. In the body 2 are housed motor, transmission, power supply, control electronics and the like which are otherwise conventional and will not be described further. A switch 4 for activation of the shaver is provided on the front of the body 2. The head 3 comprises a first housing part 5 and a second housing part t 6 on which are mounted a pair of cutter units 10. Each cutter unit 10 comprises a support member 12 which has an opening 14 through which a cap 16 protrudes. The support members 12 are mounted to float with respect to the second housing part 6, whereby they pivot about a transverse axis Z. The cap 16 has slots 18 formed through its external surface 20 as is generally conventional. The second housing part 6 is connected to the first housing part 5 and can be released by a catch 8 which allows access to the rear side of the cutter units 10

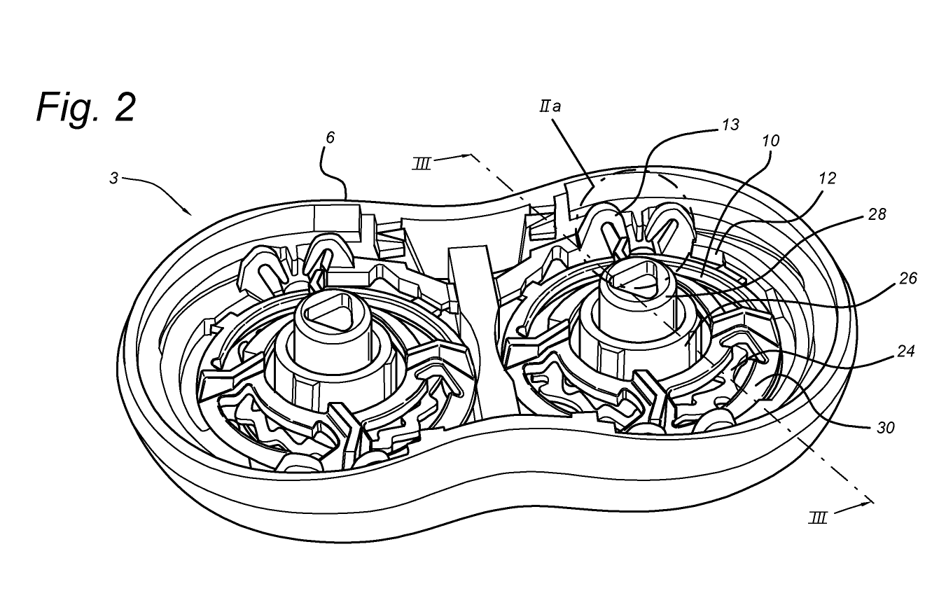

FIG. 2 shows in perspective view, the underside of the second housing part 6 of FIG. 1, detached from the body 2 of the shaver 1. In this view, it can be seen that each cutter unit 10 comprises a rotary cutter 24 having a carrier 26 and a spindle 28. A retainer 30 overlies the rotary cutter 24 and holds it in engagement with the support member 12.

FIG. 2a shows a detail of FIG. 2 illustrating the manner in which the support member 12 is held together with the second housing part 6. Trunnions 7 are formed at diametrically opposite sides of the second housing part 6 aligned with the axis Z. Clips 13 provided on the support member 12 engage the trunnions 7 to form a pivoting connection.

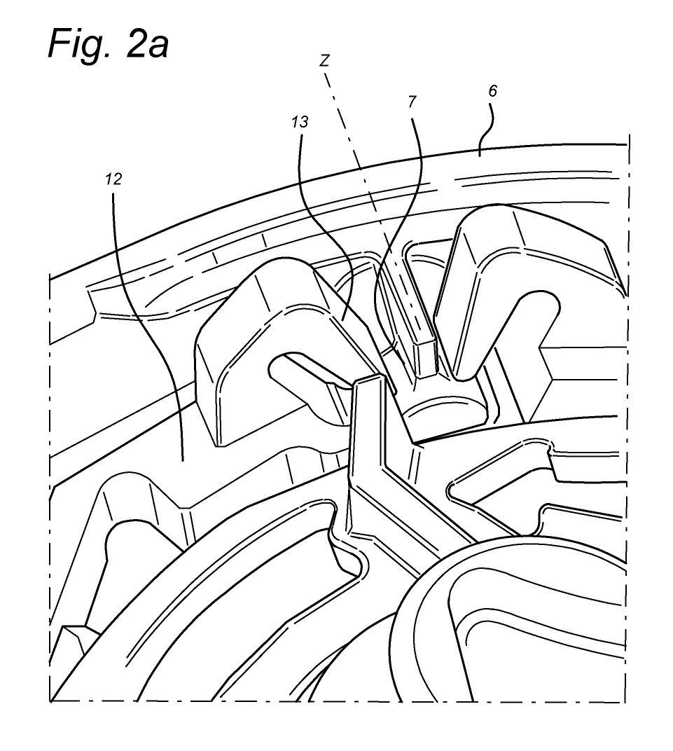

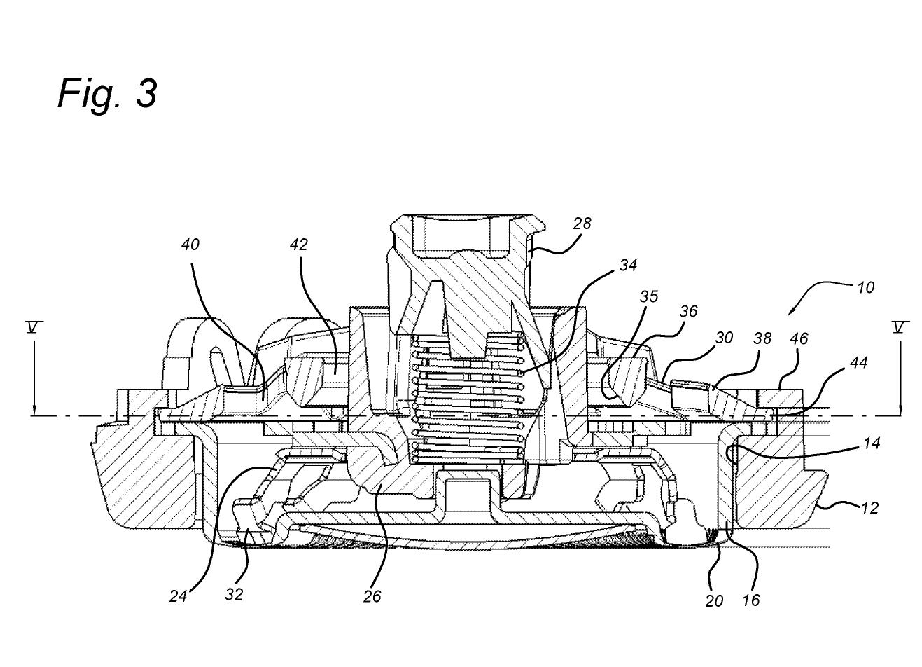

FIG. 3 shows a cross-section through the cutter unit 10 of FIG. 2 along line III-III. Cap 16 protrudes through opening 14 in support member 12 such that its external surface 20 extends slightly beyond the support member 12. Within the cap 16 the rotary cutter 24 has cutting elements 32 supported by carrier 26. The cutting elements 32 engage against the cap 16 under the force of a spring 34 which is mounted between the carrier 26 and the spindle 28. The retainer 30 comprises an inner ring 36 and an outer ring 38 with holes 40 formed between them. The inner ring 36 defines a drive opening 42 through which the spindle 28 extends. The outer ring 38 carries lugs 44 at its outer circumference, which engage beneath inwardly extending flanges 46 formed on the support 12. Lugs 44 and flanges 46 act as locking elements forming a bayonet connection between the retainer 30 and support member 12. A lower surface of the inner ring 36 directed towards the external surface 20 of the cap 16 is provided with tapered surfaces 35. In use, the tapered surfaces 35 facilitate passage of cut hairs and shaving debris through the holes 40.

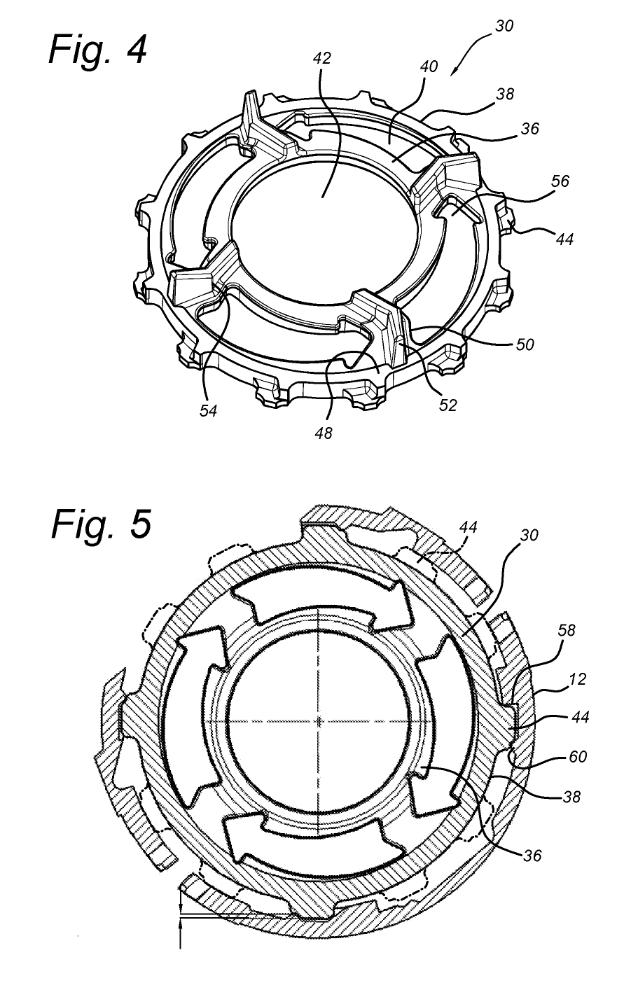

FIG. 4 shows the retainer 30 of FIG. 3 in perspective view illustrating the inner ring 36, the outer ring 38, the drive opening 42, the holes 40 and the lugs 44. As can be better appreciated in this view, the inner ring 36 and the outer ring 38 are joined to each other by cross-members 50 whereby the retainer 30 defines a generally annular body 48 surrounding the drive opening 42. Formed on the cross-members 50 are gripping protrusions 52 having the form of chevrons. A tip 54 of the chevron shaped protrusion 52 points in an anti-clockwise direction when viewed from above. In the illustrated embodiment, there are four cross-members 50 with four holes 40 formed in between them. Each hole 40 has the shape of an arrow with a tip 56 of each arrow shape pointing in the same anti-clockwise direction as the tips 54 of the chevrons.

FIG. 5 shows a horizontal cross-sectional view from below through the cutter unit of FIG. 3 along line V-V illustrating the manner in which the bayonet connection is formed between retainer 30 and support member 12. Lugs 44 formed on outer ring 38 are shown engaged with abutments 58 on the support member 12, which limit the degree of relative rotation of these two components. Also shown are detents 60 provided on the support member 12 at the point of engagement with the lugs 44. It will be noted in this view that only four lugs are shown engaging with four abutments.

Operation of the retainer 30 will now be explained with reference to FIGS. 1 to 5. When a user desires to clean the shaver 1, he removes the second housing part 6 from the body 2 by engaging the catch 8 and then turns the second housing part 6 upside down to the position of FIG. 2. He may then release the retainer 30 by engaging the gripping protrusions 52 with his fingers. On applying a force in the direction indicated by the arrow-shaped holes 40 and the chevron shaped gripping protrusions 52, the lugs 44 move past the detents 60. The presence of these directional formations provides an immediate visual indication that the retainer 30 is to be turned and also as to the direction that it should be turned. As the retainer 30 is rotated with respect to the support member 12, the lugs 44 disengage from beneath the flanges 46 and the retainer 30 can be retracted from the support member 12. Once the retainer 30 has been removed, the rotary cutter 24 can also be removed and cleaned or replaced, as can be the cap 16. Re-assembly takes place in the same way by reversing the above sequence.

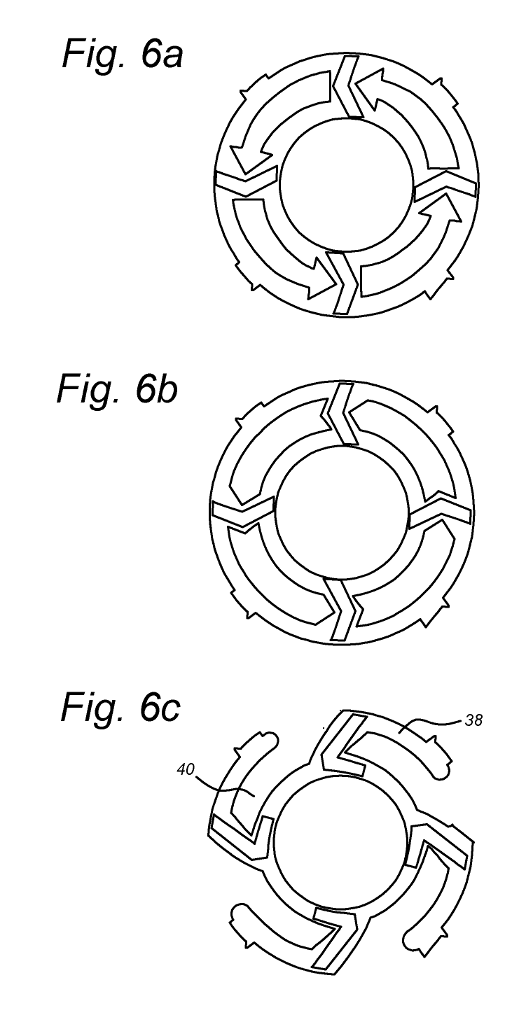

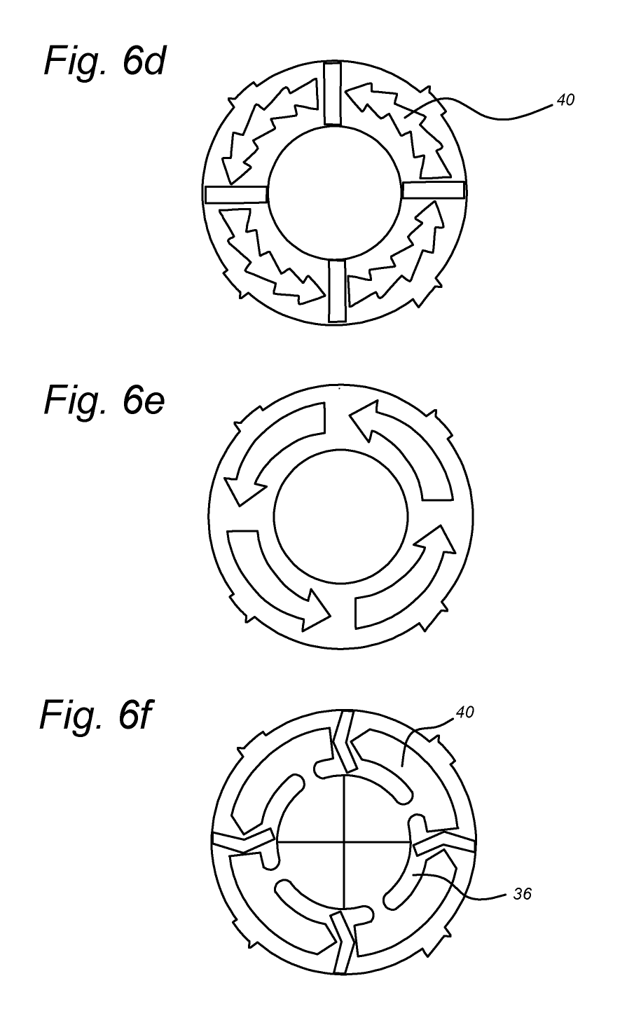

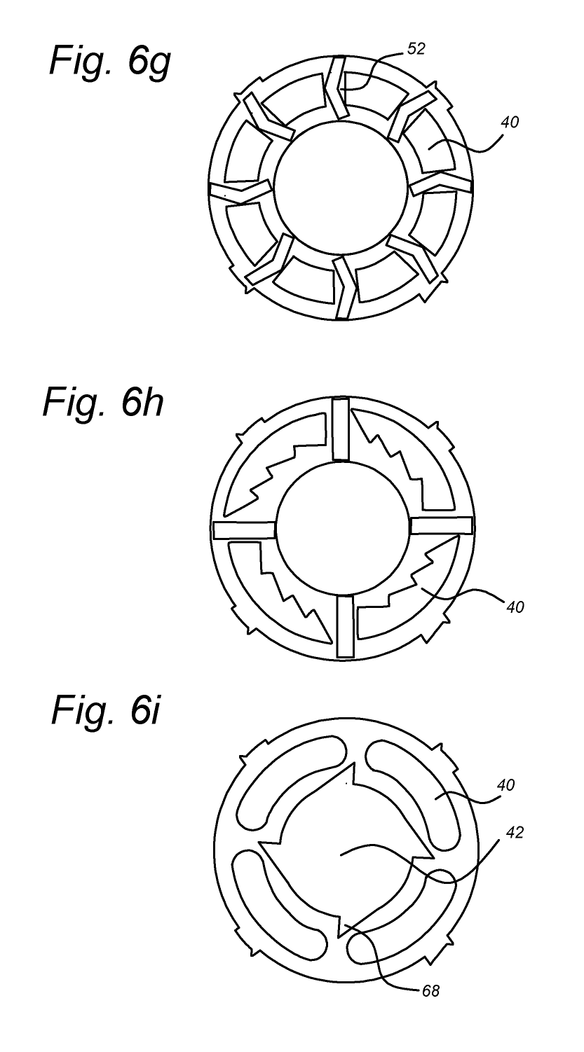

FIGS. 6a to 6i represent a number of alternative designs for the retainer 30. In FIGS. 6d and 6h the directional formations are provided by the holes 40 only. In FIG. 6g, only the gripping protrusions 52 are formed as directional formations and the holes 40 are generally rectangular. In FIG. 6e, no gripping protrusions are present. In FIG. 6g the number of holes 40 is greater than in the other devices. In FIG. 6c, the holes 40 extend through the outer ring 38, which is discontinuous. In FIG. 6f, the holes 40 extend through the inner ring 36 which is discontinuous. FIG. 6i represents a particular example where the drive opening 42 is provided with directional formations 68.

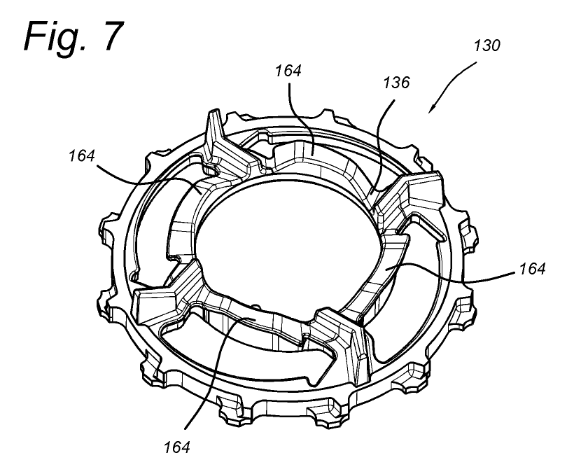

FIG. 7 shows a retainer 130 according to a second embodiment of the invention. In this embodiment, the inner ring 136 is provided with lifting elements 164. The lifting elements 164 are formed as partial undercut portions at an outer circumference of the inner ring 136. Operation of the retainer 130 of FIG. 7 is substantially the same as that of FIG. 4. On release of the retainer from the support member, a user's fingers can engage beneath the lifting elements in order to better withdraw the retainer 130 from the support member.

Thus, the invention has been described by reference to certain embodiments discussed above. It will be recognized that these embodiments are susceptible to various modifications and alternative forms well known to those of skill in the art. In particular, the arrangements of FIGS. 6a to 6i are exemplary and that many further designs and configurations may also be considered which can provide equal or similar benefits.

Many modifications in addition to those described above may be made to the structures and techniques described herein without departing from the spirit and scope of the invention. Accordingly, although specific embodiments have been described, these are examples only and are not limiting upon the scope of the invention.

1. A rotary shaving head having at least one cutter unit, wherein each cutter unit comprises:
a cap having an external surface with hair-entry openings for engaging the skin of a user; and
a rotary cutter having cutting elements supported by a carrier, the rotary cutter being locatable within and rotatable with respect to the cap;
and wherein the shaving head further comprises:
a support member for supporting the cutter unit; and
a retainer, arranged to engage and lock with the support member by relative rotation therewith and retain the cap and the rotary cutter there between, wherein the retainer comprises an annular body defining a drive opening, the annular body being provided with one or more holes allowing cut hairs to pass through, wherein the holes are shaped as directional indicators indicating a direction of rotation of the retainer with respect to the support member.

2. The shaving head according to claim 1, wherein the retainer and the support member comprise locking elements that engage and lock against one another by rotation.

3. The shaving head according to claim 2 wherein the locking elements comprise bayonet elements having lugs on an outer circumference of the retainer which engage beneath inwardly extending flanges formed on the support member.

4. The shaving head according to claim 2, wherein the locking elements are provided with detent elements.

5. The shaving head according to claim 1, wherein the retainer is provided with gripping protrusions for rotating the retainer with respect to the support member.

6. The shaving head according to claim 5, wherein the gripping protrusions are formed as further directional indicators which also indicate a direction of rotation of the retainer with respect to the support member.

7. The shaving head according to claim 1, wherein the holes are formed in the shape of arrows or chevrons.

8. The shaving head according to claim 1, comprising at least three holes arranged around a circumference of the annular body.

9. The shaving head according to claim 1, wherein the annular body comprises an outer ring and an inner ring which surrounds the drive opening, the one or more holes being located radially outwardly of the inner ring between the outer ring and the inner ring.

10. The shaving head according to claim 9, wherein the annular body is provided with lifting elements for assisting a user in withdrawing the retainer from the support member once unlocked, the lifting elements comprising undercut portions at an outer circumference of the inner ring.

11. The shaving head according to claim 1, wherein the annular body is provided with tapered surfaces at a side directed towards the external surface of the cap, the tapered surfaces facilitating passage of the cut hairs through the one or more holes.

12. The shaving head according to claim 1, wherein the rotary cutter comprises a spring-loaded drive spindle resiliently engaged with the carrier and passing through the drive opening when the retainer is engaged and locked with the support member.

13. The shaving head according to claim 1, wherein the support member is a pivotable skin supporting rim which surrounds the cap and is mounted to pivot with respect to a housing of the shaving head during use.

14. The shaving head according to claim 13, comprising a plurality of cutter units each supported by a respective pivotable skin supporting rim.

15. The shaving head according to claim 1, wherein the support member forms part of a first housing part of the shaving head which can be moved or pivoted relative to a second housing part of the shaving head into an open position allowing access to the retainer for unlocking the retainer from the support member.

16. A shaver comprising a main body and a shaving head according to claim 1.
